(19) United States
(12) Patent Application Publication
(10) Pub. No.: US 2026/0044305 A1
(43) Pub. Date: Feb. 12, 2026

(54) METHOD FOR ADJUSTING VOLUME, ELECTRONIC DEVICE, AND NON-TRANSITORY COMPUTER-READABLE STORAGE MEDIUM

(71) Applicant: Beijing Zitiao Network Technology Co., Ltd., Beijing (CN)

(72) Inventor: Ye MA, Beijing (CN)

(21) Appl. No.: 19/277,205

(22) Filed: Jul. 22, 2025

(30) Foreign Application Priority Data
Aug. 8, 2024 (CN) 202411088514.7

(51) Int. Cl. G06F 3/16

(52) U.S. Cl. CPC G06F 3/165

(57) ABSTRACT

The present disclosure provides a method for adjusting volume, an electronic device, and a non-transitory computer-readable storage medium. The method for adjusting volume includes: determining a volume adjustment probability of target media data during its playback at a preset volume based on a historical playback record of the target media data, wherein the historical playback record includes a volume adjustment record of the target media data during its playbacks in the past; in response to that the volume adjustment probability is greater than a first threshold, determining a first probability for increasing the preset volume and a second probability for reducing the preset volume based on the volume adjustment record; based on a comparison result between the first probability and the second probability, determining a target adjustment policy; and adjusting the preset volume according to the target adjustment policy to determine a to-be-played volume of the target media data.

### CROSS-REFERENCE TO RELATED APPLICATION

This application claims the priority to and benefits of the Chinese Patent Application, No. 202411088514.7, which was filed on Aug. 8, 2024. The aforementioned patent application is hereby incorporated by reference in its entirety.

### TECHNICAL FIELD

The present disclosure relates to the field of computer technologies, and in particular, to a method for adjusting volume, an electronic device, and a non-transitory computer-readable storage medium.

### BACKGROUND

In related technologies, when media data is played on a terminal, the media data is equalized to ensure balanced playback loudness. However, in the actual playback process, a user still needs to manually adjust certain media data after it is equalized, which affects the user experience.

### SUMMARY

In view of this, the present disclosure provides a method for adjusting volume, an electronic device, and a non-transitory computer-readable storage medium to solve the problem that the volume of media data needs to be manually adjusted by a user.

In a first aspect, the present disclosure provides a method for adjusting volume, including:
determining a volume adjustment probability of target media data during its playback at a preset volume based on a historical playback record of the target media data, the historical playback record includes a volume adjustment record of the target media data during its playbacks in the past;
determining, in response to that the volume adjustment probability is greater than a first threshold, a first probability for increasing the preset volume and a second probability for reducing the preset volume based on the volume adjustment record;
determining, based on a comparison result between the first probability and the second probability, a target adjustment policy; and
adjusting the preset volume according to the target adjustment policy to determine a to-be-played volume of the target media data.

In a second aspect, the present disclosure provides an electronic device including: a memory and a processor communicatively connected to the memory, the memory is configured to store a computer instruction, and the processor is configured to execute the computer instruction to implement the method for adjusting volume in the first aspect or any of the implementations thereof.

In a third aspect, the present disclosure provides a non-transitory computer-readable storage medium, the non-transitory computer-readable storage medium has a computer instruction stored thereon, the computer instruction enables a computer to implement the method for adjusting volume in the first aspect or any of the implementations thereof.

### BRIEF DESCRIPTION OF DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a flow chart of a method for adjusting volume provided in an embodiment of the present disclosure;

FIG. 2 is a flow chart of another method for adjusting volume provided in an embodiment of the present disclosure;

FIG. 3 is a flow chart of yet another method for adjusting volume provided in an embodiment of the present disclosure;

FIG. 4 is a flow chart of yet another method for adjusting volume provided in an embodiment of the present disclosure;

FIG. 5 is a flow chart of another method for adjusting volume provided in an embodiment of the present disclosure;

FIG. 6 is a structural block diagram of an apparatus for adjusting volume provided in an embodiment of the present disclosure; and

FIG. 7 is a hardware structural schematic diagram of an electronic device provided in an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

In related technologies, when media data is played on a terminal, the media data is equalized to ensure balanced playback loudness. However, in the actual playback process, after certain media data is equalized, the playback volume still cannot meet the requirements of a user, which requires the user to manually increase or reduce the volume, and affects the user experience.

In view of this, the embodiments of the present disclosure provide a method for adjusting volume, which effectively reduces the number of times that the media data requires volume adjustment during the playback, thereby improving the playback effect of the media data.

The method for adjusting volume provided in present embodiment is capable of determining a volume adjustment probability of the target media data during its playback at a preset volume based on a historical playback record of the target media data. Furthermore, in the situation that the volume adjustment probability is greater than a first threshold, the preset volume can be adjusted by adopting an appropriate target adjustment policy based on a comparison result between a first probability for increasing the preset volume and a second probability for reducing the preset volume, such that the obtained playback volume is more consistent with the expectation, thereby reducing the probability of adjusting the volume of the target media data during its playback process, and improving the playback effect of the media data

According to the embodiments of the present disclosure, an embodiment of a method for adjusting volume is provided. It should be noted that the steps shown in the flow chart may be implemented in a computer system such as a set of computer executable instructions, and although a logical sequence is shown in the flow chart, in some cases, the steps shown or described may be executed in an order different from that presented herein.

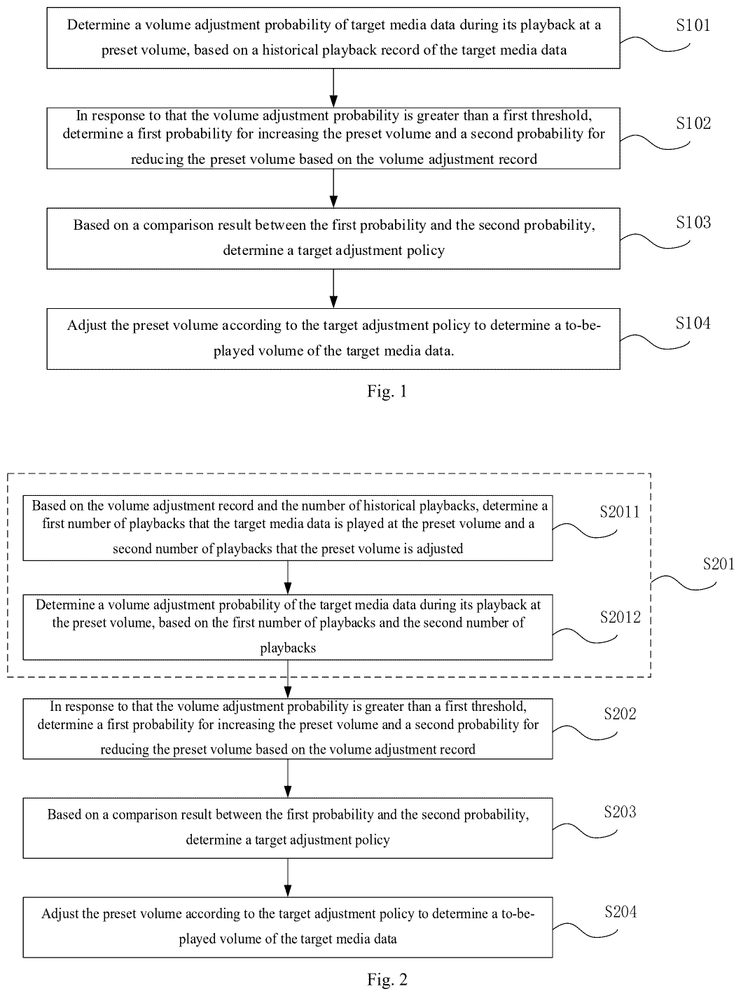

The present embodiment provides a method for adjusting volume that can be applied to an electronic device, such as a mobile phone, a tablet, and the like. FIG. 1 is a flow chart of a method for adjusting volume according to an embodiment of the present disclosure. As shown in FIG. 1, and the method includes the following steps:

Step S101: Determine a volume adjustment probability of target media data during its playback at a preset volume, based on a historical playback record of the target media data.

The target media data may be understood as any one of media data that needs to be played. For example, the target media data may be an audio or a video that needs to be played. The historical playback record includes a volume adjustment record of the target media data during its playbacks in the past. The volume adjustment record is configured to record the volume adjustment situation of the target media data during its playback process in the past. The preset volume may be a volume at which the target media data is played at any one or more playbacks in the past.

In order to determine whether the volume adjustment is necessary during its playbacks at the preset volume, the volume adjustment situation of the target media data during each playback in the past is determined based on the historical playback record of the target media data. The volume adjustment situation is then analyzed, in order to determine the volume adjustment probability of the target media data during its playbacks at the preset volume. In this way, the reasonableness and accuracy of the volume adjustment can be improved when the preset volume is subsequently adjusted.

Step S102: In response to that the volume adjustment probability is greater than a first threshold, determine a first probability for increasing the preset volume and a second probability for reducing the preset volume based on the volume adjustment record.

The first threshold may be understood as a maximum volume adjustment probability where adjustment of the preset volume is determined as not necessary. If the volume adjustment probability is greater than the first threshold, it indicates that the volume will be adjusted when the target media data is played back at the preset volume. Hence, in a situation that the volume adjustment probability is determined to be greater than the first threshold, the first probability for increasing the preset volume and the second probability for reducing the preset volume are determined respectively based on the volume adjustment record, such that the subsequent adjustment of the preset volume may be determined based on the comparison result of the first probability and the second probability, so as to improve the effectiveness of the volume adjustment.

Step S103: Based on a comparison result between the first probability and the second probability, determine a target adjustment policy.

Based on the comparison result between the first probability and the second probability, an adjustment direction is determined, thereby improving the reasonableness and effectiveness of the obtained target adjustment policy. For example, if the first probability is greater than the second probability, it indicates that the probability that the preset volume is increased is greater than the probability that the preset volume is decreased during the past playbacks of the target media data. Hence, when determining the target adjustment policy subsequently, the adjustment policy to increase the preset volume is configured as the target adjustment policy. If the first probability is lower than the second probability, it indicates that the probability that the preset volume is increased is lower than the probability that the preset volume is decreased during the past playbacks of the target media data. Hence, when determining the target adjustment policy subsequently, the adjustment policy to reduce the preset volume is configured as the target adjustment policy.

Step S104: Adjust the preset volume according to the target adjustment policy to determine a to-be-played volume of the target media data.

After determining the target adjustment policy, the preset volume is adjusted according to the target adjustment policy, such that the obtained playback volume of the target media data is more in line with the playback expectation, which can effectively reduce the probability that the volume of the target media data is adjusted during its playback, so as to facilitate improving the playback effect of media data.

The method for adjusting volume provided in present embodiment is capable of determining a volume adjustment probability of the target media data during its playback at a preset volume based on a historical playback record of the target media data. Furthermore, in the situation that the volume adjustment probability is greater than a first threshold, the preset volume can be adjusted by adopting an appropriate target adjustment policy based on a comparison result between a first probability for increasing the preset volume and a second probability for reducing the preset volume, such that the obtained playback volume is more consistent with the expectation, thereby reducing the probability of adjusting the volume of the target media data during its playback process, and improving the playback effect of the media data.

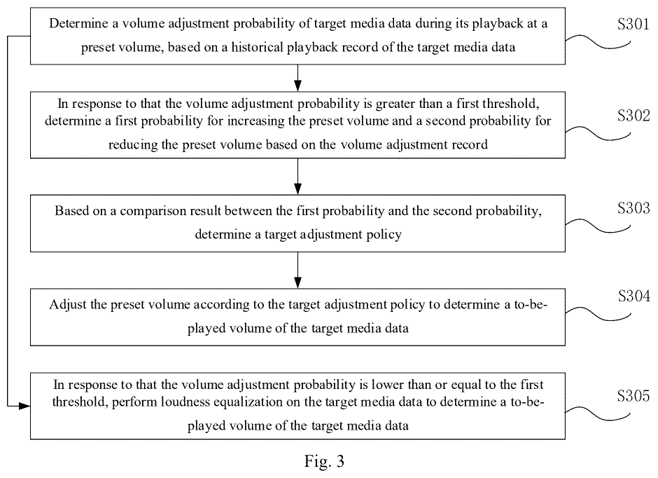

The present embodiment further provides a method for adjusting volume that can be applied to an electronic device, such as a mobile phone, a tablet, and the like. FIG. 2 is a flow chart of a method for adjusting volume according to an embodiment of the present disclosure. As shown in FIG. 2, and the method includes the following steps:

Step S201: Determine a volume adjustment probability for target media data during its playback at a preset volume, based on a historical playback record of the target media data.

As an example, the historical playback record further includes a number of historical playbacks of the target media data. The step S201 includes:

Step S2011: Based on the volume adjustment record and the number of historical playbacks, determine a first number of playbacks that the target media data is played at the preset volume and a second number of playbacks that the preset volume is adjusted.

Based on the volume adjustment record, initial volume and adjusted volume of the target media data at each playback are determined. Based on the historical playback record, a total number of playbacks of the target media data in the past is determined, that is, the historical playback times of the target media data is determined. The number of historical playbacks refers to a cumulative number of playbacks counted when the target media data is played on at least one playback device.

Because the target media data may be played back at a different volume for each playback, in order to better understand the playback of the target media data at the preset volume, the first number of playbacks that the target media data is played at the preset volume and the second number of playbacks that the preset volume is adjusted when the target media data is played at the preset volume are counted, respectively. The second number of playbacks is lower than or equal to the first number of playbacks.

Step S2012: Determine a volume adjustment probability of the target media data during its playback at the preset volume, based on the first number of playbacks and the second number of playbacks.

Based on the comparison result of the first number of playbacks and the second number of playbacks, the volume adjustment probability of the target media data during its playback process at the preset volume is determined, so as to quantify the possibility for adjusting the preset volume based on the volume adjustment probability, thereby improving the convenience and efficiency of determining the target adjustment policy.

In some optional implementations, the aforementioned step S2012 includes:
Step a1: determine a total number of historical playbacks and a total number of volume adjustments of the media data played on a playback device;
Step a2: determine a total volume adjustment probability corresponding to the playback device, based on a ratio of the total number of volume adjustments to the total number of historical playbacks;
Step a3: determine a playback probability of the target media data, based on a ratio of the first number of playbacks to the total number of historical playbacks;
Step a4, determine a third probability of adjusting the preset volume on the playback device, based on a ratio of the second number of playbacks to the total number of volume adjustments; and
Step a5: determine a volume adjustment probability of the target media data during its playback on the playback device at the preset volume, based on the third probability, the total volume adjustment probability, and the playback probability.

As an example, the total number of historical playbacks refers to the total playback volume (PV) that the media data is played on the playback device in the past. The number of playbacks of the media data is at least one, and the corresponding playback content is not limited. The total number of volume adjustments refers to the total number of times of volume adjustment for the media data during its playback on the playback device in the past. In some optional examples, in order to ensure the reliability of volume adjustment, the total number of historical playbacks and the total number of volume adjustments are counted for the media data played on the playback device within a specified time. For example, the specified time may be within 30 days from the current time or within 7 days from the current time. The time interval for the specified timed may be determined as required.

Based on the ratio of the total number of volume adjustments to the total number of historical playbacks, the probability for adjusting the volume when the media data is played on the playback device is determined. Further, the ratio is used as the total volume adjustment probability that may predict a probability that the volume of the media data will be adjusted on the playback device. For example, the total volume adjustment probability P(c) may be expressed as the following equation: P(c)=total number of volume adjustments/total number of historical playbacks.

Based on the ratio of the first number of playbacks to the total number of historical playbacks, a playback proportion of the target media data played on the playback device in the past is determined. Further, the ratio is used as a probability to predict that the target media data will be played back on the playback device, thereby obtaining a playback probability of the target media data. For example, the playback probability p(x) is expressed as the following equation: p(x)=the first number of playbacks/the total number of historical playbacks.

Based on the ratio of the second number of playbacks to the total number of volume adjustments, a volume adjustment probability of the target media data during its playback on the playback device at a preset volume is determined. Further, the ratio is used as the third probability of adjusting the preset volume on the playback device. For example, the third probability p(x|c) is expressed as the following equation: p(x|c)=the second number of playbacks/the total number of volume adjustments.

The volume adjustment probability of the target media data during its playback at the preset volume on the playback device is comprehensively evaluated and analyzed based on the third probability, the total volume adjustment probability, and the playback probability, and further in combination with the historical playback situation of the target media data and the historical playback situation when the media data is played on the playback device, thereby effectively improving the reliability and accuracy in determining the volume adjustment probability.

In some optional examples, the process for determining a volume adjustment probability includes: determining a product of the total volume adjustment probability and the third probability, and using a quotient of the product divided by the playback probability as the volume adjustment probability of the target media data during its playback at the preset volume on the playback device. That is, based on the Bayes law, the following formula is used to determine the volume adjustment probability p(c|x): p(c|x)=p(x|c)P(c)/p(x). Determining the volume adjustment probability through the aforementioned determination process reduces the influence of subjective factors, thereby providing more objective and scientific determination of the volume adjustment probability, in this way, the reasonableness and accuracy of the volume adjustment is enhanced when the volume adjustment is performed.

In some optional implementations, due to P(c)=total number of volume adjustments/total number of historical playbacks, p(x)=first number of playbacks/total number of historical playbacks, p(x|c)=second number of playbacks/total number of volume adjustments, p(c|x)=p(x|c)P(c)/p(x), the equation for determining the volume adjustment probability p(c|x) is simplified as: p(c|x)=second number of playbacks/first number of playbacks. In this way, in the situation that the first number of playbacks and the second number of playbacks are determined, the volume adjustment probability can be quickly obtained, thereby effectively improving the determination efficiency.

In other optional examples, a pre-built deep learning model is used to determine the volume adjustment probability, based on the third probability, the total volume adjustment probability, and the playback probability inputted in the pre-built deep learning model, thereby effectively reducing manual intervention and the requirements for manual analysis, and improving the efficiency of determining the volume adjustment probability.

Step S202: In response to that the volume adjustment probability is greater than a first threshold, determine a first probability for increasing the preset volume and a second probability for reducing the preset volume based on the volume adjustment record. For details, refer to step S102 of the embodiment shown in FIG. 1, which is not described again here.

Step S203: Based on a comparison result between the first probability and the second probability, determine a target adjustment policy. For details, refer to step S103 of the embodiment shown in FIG. 1, which is not described again here.

Step S204: Adjust the preset volume according to the target adjustment policy to determine a to-be-played volume of the target media data. For details, refer to step S104 of the embodiment shown in FIG. 1, which is not described again here.

In the volume adjustment method provided in present embodiment, the volume adjustment probability is determined by analyzing the volume adjustment record and the number of historical playbacks, and therefore is capable of quantifying the possibility of volume adjustment for the target media data during its playback, and then the target adjustment policy is determined based on the comparison result between the volume adjustment probability and the first threshold, which provides more reasonable and reliable target adjustment policy, thereby effectively improving the playback effect of the target media data.

In some optional examples, the process of determining the first probability includes: based on the volume adjustment record, filtering out the playback record that the volume of the target media has been adjusted during its playback at the preset volume in the past; and then based on the playback record, counting the number of playbacks that the preset volume was increased, thereby obtaining the first number of adjustments. The ratio of the first number of adjustments to the first number of playbacks is used as the first probability. Similarly, when the second probability is determined, the number of playbacks that the preset volume was decreased is determined based on the playback record, and then the second number of adjustments is obtained. The ratio of the second number of adjustments to the first number of playbacks is then used as the second probability.

In some optional embodiments, the process of determining the target adjustment policy based on the comparison result between the first probability and the second probability includes: in response to that a first difference between the first probability and the second probability is greater than a second threshold, a first adjustment policy is determined as the target adjustment policy. The second threshold is the threshold that determines whether the volume needs to be increased. The specific value of the second threshold may be set as required. For example, the second threshold is 0.4 or 0.5. If the first difference between the first probability and the second probability is greater than the second threshold, it indicates that: during the historical playback process of the target media data, when it is played at the preset volume, in most cases, the preset volume is adjusted by increasing the volume, so as to alleviate the problem that the low volume provided by the preset volume may affect the auditory effect. In this situation, the first adjustment policy for increasing the preset volume is selected as the target adjustment policy, and in the subsequent volume adjustments, the preset volume is increased to meet the playback expectations, thereby improving the playback effect of the target media data.

In some other optional implementations, in response to that the target adjustment policy is a first adjustment policy, the preset volume is adjusted according to the target adjustment policy to determine a to-be-played volume of the target media data, including: determining a maximum value of a Dynamic Range Control curve (DRC curve) according to the first adjustment policy, adjusting the preset volume based on the maximum value, and obtaining the to-be-played volume of the target media data.

As an example, the maximum value of the dynamic range control (DRC) curve is determined according to the first adjustment policy. The DRC is a way to adjust volume by compressing or extending the dynamic range of an audio signal. In order to increase the preset volume as much as possible, the maximum value of the DRC curve is determined, and the preset volume is adjusted by using the maximum value, in this way, the to-be-played volume of the target media data can meet the playback expectations.

In some other optional implementations, the process of determining the target adjustment policy based on the comparison result between the first probability and the second probability further includes: in response to that the first difference between the first probability and the second probability is lower than or equal to the second threshold, determining the target adjustment policy based on a second difference between the second probability and the first probability. If the first difference between the first probability and the second probability is lower than or equal to the second threshold, it indicates that: during the historical playback process of the target media data, when it is played at the preset volume, the situations where the preset volume is adjusted by increasing the volume are not many. Hence, in order to determine whether there were many volume decreases for the target media data volume during the historical playback process, the target adjustment policy is determined based on the second difference between the second probability and the first probability, thereby improving the accuracy of determining the target adjustment policy.

In some optional examples, in response to that the second difference is greater than a third threshold, a second adjustment policy is determined as the target adjustment policy, and the second adjustment policy is used to reduce the preset volume; and in response to that the second difference is lower than or equal to the third threshold, a third adjustment policy is determined as the target adjustment strategy, and the third adjustment policy is used to compress the DRC curve and adjust the preset volume based on the compressed DRC curve.

As an example, the third threshold is the threshold that determines whether the volume needs to be decreased. The specific value of the third threshold may be set as required. For example, the third threshold is 0.2 or 0.3. If the second difference is greater than the third threshold, it indicates that during the historical playback process of the target media data, when it is played at the preset volume, in most cases, the preset volume is adjusted by decreasing the volume, so as to alleviate the problem that the high volume provided by the preset volume may affect the auditory effect. Hence, the second adjustment policy used to reduce the preset volume is selected as the target adjustment policy, such that when the preset volume is adjusted according to the second adjustment policy in the future, the preset volume is effectively reduced to meet the playback expectations. For example, the second adjustment policy may refer to reducing the preset volume by adjusting the limit makeup gain or DRC compensation gain. For another example, the limit makeup gain or DRC compensation gain is adjusted by way of setting zero or adjusting the weight, thereby reducing the preset volume, avoiding excessive strength or distortion of the audio signal due to the excessive makeup gain, and improving the stability of the volume adjustment.

If the second difference is lower than or equal to the third threshold, it indicates that: during the historical playback process of the target media data, when it is played at the preset volume, it is possible that the preset volume is adjusted by increasing or decreasing the volume, in this situation, the third adjustment policy is selected as the target adjustment policy. When the preset volume is adjusted according to the third adjustment policy in the future, the adjusted playback volume is more stable. The third adjustment policy is used to compress the DRC curve and adjust the preset volume based on the compressed DRC curve, which effectively avoids volume fluctuation of the adjusted volume, improves the auditory impression of the target media data to a certain extent, delivers clearer and comfortable sound playback, and improves the playback quality of the target media data.

Determining the target adjustment policy based on the comparison result of the second difference and the third threshold may adapt to different playback situations more flexibly, thereby improving the quality and effect of media data playback, and meeting playback expectations.

The present embodiment further provides a method for adjusting volume that can be applied to an electronic device, such as a mobile phone, a tablet, and the like. FIG. 3 is a flow chart of a method for adjusting volume according to an embodiment of the present disclosure. As shown in FIG. 3, and the process includes the following steps:
Step S301: Determine a volume adjustment probability of target media data during its playback at a preset volume, based on a historical playback record of the target media data.
Step S302: In response to that the volume adjustment probability is greater than a first threshold, determine a first probability for increasing the preset volume and a second probability for reducing the preset volume based on the volume adjustment record.
Step S303: Based on a comparison result between the first probability and the second probability, determine a target adjustment policy.
Step S304: Adjust the preset volume according to the target adjustment policy to determine a to-be-played volume of the target media data.
Step S305: In response to that the volume adjustment probability is lower than or equal to the first threshold, perform loudness equalization on the target media data to determine a to-be-played volume of the target media data.

If the volume adjustment probability is lower than or equal to the first threshold, it indicates that: during the historical playback process of the target media data, when it is played at the preset volume, the probability of adjusting the volume of the target media data is relatively low. Hence, in order to improve the playback quality of the target media data, the loudness equalization is performed on the target media data to further optimize the audio effect of the target media data and obtain the to-be-played volume of the target media data.

In the volume adjustment method provided in present embodiment, after the volume adjustment probability of the target media data during its playback at the preset volume is determined, the to-be-played volume of the target media data can be determined based on the comparison result of the volume adjustment probability and the first threshold in different ways. In this way, the volume can be adjusted more flexibly and more purposefully, thereby effectively improving the playback quality of the target media data, reducing the probability of manual adjustment, and meeting the expectations of the user.

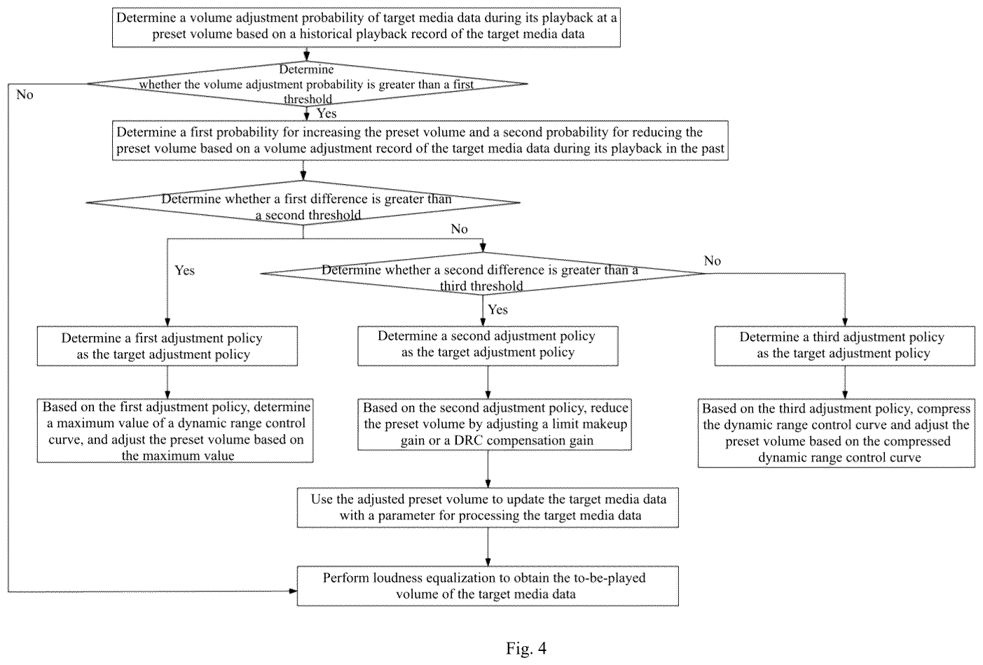

As one or more specific embodiments of the present disclosure, the process of determining the to-be-played volume of the target media data is shown in FIG. 4 and it includes the following specific processes:

Firstly, a volume adjustment probability of target media data during its playback at a preset volume is determined based on a historical playback record of the target media data.

Secondly, the volume adjustment probability is compared with a first threshold to determine whether the volume adjustment probability is greater than a first threshold.

In response to that the volume adjustment probability is lower than or equal to the first threshold, loudness equalization is performed on the target media data to determine a to-be-played volume of the target media data.

In response to that the volume adjustment probability is greater than a first threshold, a first probability for increasing the preset volume and a second probability for reducing the preset volume is determined based on a volume adjustment record of the target media data during its playback in the past. Next, whether the first difference between the first probability and the second probability is greater than a second threshold is determined. In response to that the first difference between the first probability and the second probability is greater than a second threshold, a first adjustment policy is determined as the target adjustment policy. Based on the first adjustment policy, a maximum value of a DRC curve is determined, and the preset volume is adjusted based on the maximum value. Then, the adjusted preset volume is used to update the target media data with a parameter for processing the target media data, and the updated parameter is used to carry out loudness equalization, so as to determine the to-be-played volume of the target media data.

In response to that the first difference between the first probability and the second probability is lower than or equal to the second threshold, whether a second difference between the second probability and the first probability is greater than a third threshold is determined. In response to that the second difference between the second probability and the first probability is greater than the third threshold, a second adjustment policy is determined as the target adjustment policy. Based on the second adjustment policy, the preset volume is reduced by adjusting a limit makeup gain or a DRC compensation gain, and then the adjusted preset volume is used to update the target media data with a parameter for processing the target media data, and the updated parameter is used to carry out loudness equalization, so as to determine the playback volume of the target media data.

In response to that the second difference between the second probability and the first probability is lower than or equal to the third threshold, a third adjustment policy is determined as the target adjustment policy. Based on the third adjustment policy, the DRC curve is compressed and the preset volume is adjusted based on the compressed DRC curve, and then the adjusted preset volume is used to update the target media data with a parameter for processing the target media data, and the updated parameter is used to carry out loudness equalization, so as to determine the playback volume of the target media data.

The volume adjustment through the above mode can make the process of volume adjustment more scientific and purposeful, so that the obtained to-be-played volume of the target media data is more in line with expectations, which facilitates improving the playback quality and effect of the target media data.

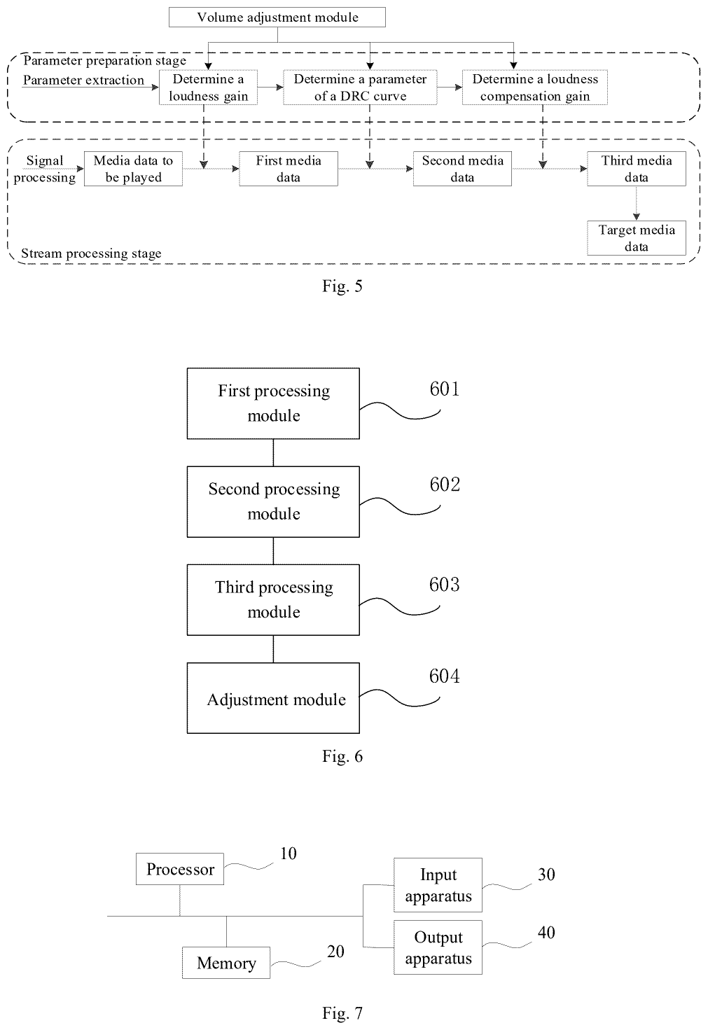

As one or more other specific embodiments of the present disclosure, the target adjustment policy is processed by a pre-built volume adjustment module. FIG. 5 illustrates a flow of processing target media data, which includes a parameter preparation stage and a stream processing stage. The preparation stage includes: determining a loudness gain, determining a parameter of a DRC curve, and determining a loudness compensation gain. Based on the target adjustment policy determined by the volume adjustment module, the loudness gain, the parameter of the DRC curve and the loudness compensation gain in the preparation stage can be adjusted purposefully, such that the loudness gain of the target media data in the stream processing stage is more reasonable and the auditory effect can meet the expectations.

The stream processing stage includes: using the loudness gain to perform loudness gain on the target media data to obtain first media data; obtaining a DRC curve by using the parameter of the DRC curve; and then obtaining second media data by using the DRC curve to perform dynamic range control of the first media data; in combination with the loudness compensation gain, performing loudness compensation on the second media data to obtain third media data; and finally, performing peak limit on the third media data to obtain the target media data.

The present embodiment further provides a volume adjustment apparatus, the apparatus is configured to implement any one of the aforementioned embodiments, among which, those that have been described are not described again here. As used herein below, the term “module” may be a combination of software and/or hardware that implements a predetermined function. Although the apparatus described in the following embodiments is preferably embodied in software, it may also be possible and conceivable that the apparatus is embodied in hardware, or a combination of software and hardware.

The present embodiment provides a volume adjustment apparatus, as shown in FIG. 6, including:
a first processing module 601, configured to determine a volume adjustment probability of target media data during its playback at a preset volume based on a historical playback record of the target media data, the historical playback record includes a volume adjustment record of the target media data during its playbacks in the past;
a second processing module 602, configured to determine a first probability for increasing the preset volume and a second probability for reducing the preset volume based on the volume adjustment record, in response to that the volume adjustment probability is greater than a first threshold;
a third processing module 603, configured to determine a target adjustment policy based on a comparison result between the first probability and the second probability; and
an adjustment module 604, configured to adjust the preset volume according to the target adjustment policy to determine a to-be-played volume of the target media data.

In some optional implementations, the historical playback record further includes a number of historical playbacks of the target media data. The first processing module 601 includes:
a first statistical unit, configured to determine a first number of playbacks that the target media data is played at the preset volume and a second number of playbacks that the preset volume is adjusted based on the volume adjustment record and the number of historical playbacks; and
a second statistical unit, configured to determine a volume adjustment probability of the target media data during its playback at the preset volume based on the first number of playbacks and the second number of playbacks.

In some optional implementations, the second statistical unit includes:
a first determination unit, configured to determine a total number of historical playbacks and a total number of volume adjustments of the media data played on a playback device;
a second determination unit, configured to determine a total volume adjustment probability corresponding to the playback device based on a ratio of the total number of volume adjustments to the total number of historical playbacks;
a third determination unit, configured to determine a playback probability of the target media data based on a ratio of the first number of playbacks to the total number of historical playbacks;
a fourth determination unit, configured to determine a third probability of adjusting the preset volume on the playback device based on a ratio of the second number of playbacks to the total number of volume adjustments; and
a fifth determination unit, configured to determine a volume adjustment probability of the target media data during its playback on the playback device at the preset volume based on the third probability, the total volume adjustment probability, and the playback probability.

In some optional implementations, the fifth determination unit includes:
a first execution unit, configured to determine a product of the total volume adjustment probability and the third probability, and use a quotient of the product divided by the playback probability as the volume adjustment probability of the target media data during its playback at the preset volume on the playback device.

In some optional implementations, the third processing module 603 includes:
a first policy determination unit, configured to in response to that a first difference between the first probability and the second probability is greater than a second threshold, determine a first adjustment policy as the target adjustment policy, the first adjustment policy is configured to increase the preset volume.

In some optional implementations, the adjustment module 604 includes:
a second execution unit, configured to determine a maximum value of a DRC curve according to the first adjustment policy, adjust the preset volume based on the maximum value to obtain the to-be-played volume of the target media data.

In some optional implementations, the third processing module 603 further includes:
a sixth determination unit, configured to, in response to that the first difference between the first probability and the second probability is lower than or equal to the second threshold, determine the target adjustment policy based on a second difference between the second probability and the first probability.

In some optional implementations, the sixth determination unit includes:
a second policy determination unit, configured to, in response to that the second difference is greater than a third threshold, determine a second adjustment policy as the target adjustment policy, the second adjustment policy is configured to reduce the preset volume;
a third policy determination unit, configured to, in response to that the second difference is lower than or equal to the third threshold, determine a third adjustment policy as the target adjustment policy, the third adjustment policy is configured to compress the DRC curve and adjust the preset volume based on the compressed DRC curve.

In some optional implementations, the apparatus further includes:
a fourth processing module configured to, in response to that the volume adjustment probability is lower than or equal to the first threshold, perform loudness equalization on the target media data to determine the to-be-played volume of the target media data.

The further functional descriptions of the aforementioned modules and units are the same as the aforementioned corresponding embodiments, and are not described again here.

The volume adjustment apparatus in present embodiment is presented in the form of a functional unit, where the unit refers to an application-specific integrated circuit (ASIC), a processor and memory that execute one or more software or fixed programs, and/or other devices that can provide the aforementioned functions.

The embodiments of the present disclosure further provide an electronic device with a volume adjusting apparatus as shown in FIG. 6 above.

Referring to FIG. 7, FIG. 7 is a schematically structural diagram of an electronic device provided by an embodiment of the present disclosure. The electronic device, as shown in FIG. 7, includes: one or more processors 10, a memory 20, and interfaces for connecting various components, including a high speed interface and a low speed interface. The various components are communicatively connected to each other utilizing different buses and may be mounted on a common motherboard or otherwise mounted as desired. The processor may process instructions executed within the electronic device. The instructions include instructions stored in memory, or instructions stored on memory to display graphical information of the GUI (Graphical User Interface) on an external input/output apparatus (e.g., a display device coupled to the interface). In some optional implementations, multiple processors and/or multiple buses may be used with multiple memories. Similarly, a plurality of electronic devices may be connected with each other, and the individual device provides some of the necessary operations (e.g., as an array of servers, a group of blade servers, or a multiprocessor system). The processor 10 in FIG. 7 is used as an example.

The processor 10 may be a central processor, a network processor, or a combination thereof. Among other things, the processor 10 may further include a hardware chip. The hardware chip may be a specialized integrated circuit, a programmable logic device, or a combination thereof. The above-described programmable logic device may be a complex programmable logic device, a field programmable logic gate array, a general purpose array logic, or any combination thereof.

For example, the memory 20 stores instructions executable by the at least one processor 10 to cause the at least one processor 10 to perform a method of realizing the embodiments illustrated above.

The memory 20 may include a storage program region and a storage data region. The storage program region may store an operating system, an application program required for at least one function; and the storage data region may store data created based on the use of the electronic device, and the like. In addition, the memory 20 may include a high-speed random access memory, and may also include a non-transitory memory, such as at least one disk memory device, a flash memory device, or other non-transitory solid state memory device. In some optional implementations, the memory 20 may optionally include memories remotely located relative to the processor 10, and these remote memories may be connected to the electronic device via a network. Examples of the networks include, but are not limited to, the Internet, an enterprise intranet, a local area network, a mobile communications network, and combinations thereof.

The memory 20 may include volatile memory, e.g., random access memory; the memory may also include non-volatile memory, e.g., flash memory, a hard disk, or a solid state drive; and the memory 20 may also include a combination of the above types of memory.

The electronic device further includes an input apparatus 30 and an output apparatus 40. The processor 10, the memory 20, the input apparatus 30, and the output apparatus 40 may be connected via a bus or otherwise. The bus in FIG. 7 is used as an example of the connection via a bus.

The input apparatus 30 may receive incoming numeric or character information, as well as generate inputs of key signals related to user settings as well as function control of the electronic device, such as a touch screen, a keypad, a mouse, a trackpad, a touchpad, an indicator bar, one or more mouse buttons, a trackball, a joystick, and the like. The output apparatus 40 may include a display device, an auxiliary lighting apparatus (e.g., a Light Emitting Diode, LED), and a haptic feedback apparatus (e.g., a vibration motor), among others. The aforementioned display devices include, but are not limited to, liquid crystal displays, light emitting diodes, monitors, and plasma displays. In some optional embodiments, the display device may be a touch screen.

Embodiments of the present disclosure further provide a computer-readable storage medium, the abovementioned methods according to embodiments of the present disclosure may be implemented in hardware, firmware, or implemented as computer code that may be recorded on a storage medium, or implemented as computer code that is originally stored on a remote storage medium or a non-transitory computer-readable storage medium that is downloaded over a network and that is to be stored on a local storage medium such that the herein described The method may be processed by such software stored on a storage medium using a general-purpose computer, a dedicated processor, or programmable or specialized hardware. Among other things, the storage medium may be a magnetic disk, an optical disc, a read-only storage memory, a random storage memory, a flash memory, a hard disk, or a solid state drive; further, the storage medium may include a combination of the above types of memory. It will be appreciated that the computer, processor, microprocessor controller, or programmable hardware includes a storage component that can store or receive software or computer code, and when the software or computer code is accessed by the computer, processor, or hardware and is executed, the method illustrated in the above embodiments is realized.

A portion of the present disclosure may be applied as a computer program product, such as computer program instructions, which, when executed by a computer, by operation of that computer, may invoke or provide a method and/or technical solution according to the present disclosure. A person skilled in the art should be able to understand that the forms in which the computer program instructions exist in a computer-readable medium include, but are not limited to, a source file, an executable file, an installer file, and the like, and accordingly, the ways in which the computer program instructions are executed by a computer include, but are not limited to, the computer directly executing the instructions, or the computer compiling the instructions and then executing the corresponding post-compilation program, or the computer reading and executing the instructions, or the computer reads and installs the instructions and then executes a corresponding post-installation program. Here, the computer-readable medium may be any available computer-readable storage medium or communication medium accessible to the computer.

Although embodiments of the present disclosure are described in conjunction with the accompanying drawings, a person skilled in the art may make various modifications and variations without departing from the spirit and scope of the present disclosure, and such modifications and variations fall within the scope limited by the present disclosure.

1. A method for adjusting volume, comprising:
determining a volume adjustment probability of target media data during its playback at a preset volume based on a historical playback record of the target media data, wherein the historical playback record comprises a volume adjustment record of the target media data during its playbacks in the past;
determining, in response to that the volume adjustment probability is greater than a first threshold, a first probability for increasing the preset volume and a second probability for reducing the preset volume based on the volume adjustment record;
determining, based on a comparison result between the first probability and the second probability, a target adjustment policy; and
adjusting the preset volume according to the target adjustment policy to determine a to-be-played volume of the target media data.

2. The method according to claim 1, wherein the historical playback record further comprises a number of historical playbacks of the target media data; and the determining a volume adjustment probability of target media data during its playback at a preset volume based on a historical playback record of the target media data comprises:
determining, based on the volume adjustment record and the number of historical playbacks, a first number of playbacks that the target media data is played at the preset volume and a second number of playbacks that the preset volume is adjusted, wherein the second number of playbacks is lower than or equal to the first number of playbacks; and
determining the volume adjustment probability of the target media data during its playback at the preset volume, based on the first number of playbacks and the second number of playbacks.

3. The method according to claim 2, wherein the determining the volume adjustment probability of the target media data during its playback at the preset volume based on the first number of playbacks and the second number of playbacks comprises:
determining a total number of historical playbacks and a total number of volume adjustments of the media data played on a playback device;
determining a total volume adjustment probability corresponding to the playback device based on a ratio of the total number of volume adjustments to the total number of historical playbacks;
determining a playback probability of the target media data based on a ratio of the first number of playbacks to the total number of historical playbacks;
determining a third probability of adjusting the preset volume on the playback device based on a ratio of the second number of playbacks to the total number of volume adjustments; and
determining the volume adjustment probability of the target media data during its playback on the playback device at the preset volume, based on the third probability, the total volume adjustment probability, and the playback probability.

4. The method according to claim 3, wherein the determining the volume adjustment probability of the target media data during its playback at the preset volume on the playback device based on the third probability, the total volume adjustment probability, and the playback probability comprises:
determining a product of the total volume adjustment probability and the third probability, and using a quotient of the product divided by the playback probability as the volume adjustment probability of the target media data back at the preset volume on the playback device.

5. The method according to claim 1, wherein the determining a target adjustment policy based on a comparison result between the first probability and the second probability comprises:
determining, in response to that a first difference between the first probability and the second probability is greater than a second threshold, a first adjustment policy as the target adjustment policy, wherein the first adjustment policy is configured to increase the preset volume.

6. The method according to claim 5, wherein the adjusting the preset volume according to the target adjustment policy to determine a to-be-played volume of the target media data comprises:
determining a maximum value of a dynamic range control curve according to the first adjustment policy, and adjusting the preset volume based on the maximum value to obtain the to-be-played volume of the target media data.

7. The method according to claim 1, wherein the determining a target adjustment policy based on a comparison result between the first probability and the second probability further comprises:
determining, in response to that the first difference between the first probability and the second probability is lower than or equal to the second threshold, the target adjustment policy based on a second difference between the second probability and the first probability.

8. The method according to claim 7, wherein the determining the target adjustment policy based on a difference between the second probability and the first probability comprises:
determining, in response to that the second difference is greater than a third threshold, a second adjustment policy as the target adjustment policy, wherein the second adjustment policy is configured to reduce the preset volume;
determining, in response to that the second difference is lower than or equal to the third threshold, a third adjustment policy as the target adjustment policy, wherein the third adjustment policy is configured to compress a dynamic range control curve and adjust the preset volume based on the compressed dynamic range control curve.

9. The method according to claim 1, further comprising:
performing, in response to that the volume adjustment probability is lower than or equal to the first threshold, loudness equalization on the target media data to determine the to-be-played volume of the target media data.

10. An electronic device, comprising:
a memory; and
a processor, configured to communicatively connect to the memory,
wherein the memory is configured to store a computer instruction, and the processor is configured to execute the computer instruction to implement a method for adjusting volume,
wherein the method for adjusting volume comprises:
determining a volume adjustment probability of target media data during its playback at a preset volume based on a historical playback record of the target media data, wherein the historical playback record comprises a volume adjustment record of the target media data during its playbacks in the past;
determining, in response to that the volume adjustment probability is greater than a first threshold, a first probability for increasing the preset volume and a second probability for reducing the preset volume based on the volume adjustment record;
determining, based on a comparison result between the first probability and the second probability, a target adjustment policy; and
adjusting the preset volume according to the target adjustment policy to determine a to-be-played volume of the target media data.

11. The electronic device according to claim 10, the historical playback record further comprises a number of historical playbacks of the target media data; and the determining a volume adjustment probability of target media data during its playback at a preset volume based on a historical playback record of the target media data comprises:
based on the volume adjustment record and the number of historical playbacks, determining a first number of playbacks that the target media data is played at the preset volume and a second number of playbacks that the preset volume is adjusted, wherein the second number of playbacks is lower than or equal to the first number of playbacks; and
determining the volume adjustment probability of the target media data during its playback at the preset volume, based on the first number of playbacks and the second number of playbacks.

12. The electronic device according to claim 11, the determining the volume adjustment probability of the target media data during its playback at the preset volume based on the first number of playbacks and the second number of playbacks comprises:
determining a total number of historical playbacks and a total number of volume adjustments of the media data played on a playback device;
determining a total volume adjustment probability corresponding to the playback device based on a ratio of the total number of volume adjustments to the total number of historical playbacks;
determining a playback probability of the target media data based on a ratio of the first number of playbacks to the total number of historical playbacks;
determining a third probability of adjusting the preset volume on the playback device based on a ratio of the second number of playbacks to the total number of volume adjustments; and
determining the volume adjustment probability of the target media data during its playback on the playback device at the preset volume, based on the third probability, the total volume adjustment probability, and the playback probability.

13. The electronic device according to claim 12, the determining the volume adjustment probability of the target media data during its playback at the preset volume on the playback device based on the third probability, the total volume adjustment probability, and the playback probability comprises:
determining a product of the total volume adjustment probability and the third probability, and using a quotient of the product divided by the playback probability as the volume adjustment probability of the target media data back at the preset volume on the playback device.

14. The electronic device according to claim 10, the determining a target adjustment policy based on a comparison result between the first probability and the second probability comprises:
determining, in response to that a first difference between the first probability and the second probability is greater than a second threshold, a first adjustment policy as the target adjustment policy, wherein the first adjustment policy is configured to increase the preset volume.

15. The electronic device according to claim 14, the adjusting the preset volume according to the target adjustment policy to determine a to-be-played volume of the target media data comprises:
determining a maximum value of a dynamic range control curve according to the first adjustment policy, and adjusting the preset volume based on the maximum value to obtain the to-be-played volume of the target media data.

16. The electronic device according to claim 10, the determining a target adjustment policy based on a comparison result between the first probability and the second probability further comprises:
determining, in response to that the first difference between the first probability and the second probability is lower than or equal to the second threshold, the target adjustment policy based on a second difference between the second probability and the first probability.

17. The electronic device according to claim 16, the determining the target adjustment policy based on a difference between the second probability and the first probability comprises:
determining, in response to that the second difference is greater than a third threshold, a second adjustment policy as the target adjustment policy, wherein the second adjustment policy is configured to reduce the preset volume;
determining, in response to that the second difference is lower than or equal to the third threshold, a third adjustment policy as the target adjustment policy, wherein the third adjustment policy is configured to compress a dynamic range control curve and adjust the preset volume based on the compressed dynamic range control curve.

18. The electronic device according to claim 10, further comprising:
performing, in response to that the volume adjustment probability is lower than or equal to the first threshold, loudness equalization on the target media data to determine the to-be-played volume of the target media data.

19. A non-transitory computer-readable storage medium, wherein the non-transitory computer-readable storage medium having a computer instruction stored thereon,
wherein the computer instruction is configured to enable a computer to implement a method for adjusting volume,
wherein the method for adjusting volume comprises:
determining a volume adjustment probability of target media data during its playback at a preset volume based on a historical playback record of the target media data, wherein the historical playback record comprises a volume adjustment record of the target media data during its playbacks in the past;
determining, in response to that the volume adjustment probability is greater than a first threshold, a first probability for increasing the preset volume and a second probability for reducing the preset volume based on the volume adjustment record;
determining, based on a comparison result between the first probability and the second probability, determining a target adjustment policy; and
adjusting the preset volume according to the target adjustment policy to determine a to-be-played volume of the target media data.

20. The non-transitory computer-readable storage medium according to claim 19, the historical playback record further comprises a number of historical playbacks of the target media data; and the determining a volume adjustment probability of target media data during its playback at a preset volume based on a historical playback record of the target media data comprises:
determining, based on the volume adjustment record and the number of historical playbacks, a first number of playbacks that the target media data is played at the preset volume and a second number of playbacks that the preset volume is adjusted, wherein the second number of playbacks is lower than or equal to the first number of playbacks; and
determining the volume adjustment probability of the target media data during its playback at the preset volume, based on the first number of playbacks and the second number of playbacks.
